(19) United States
(12) Patent Application Publication
(10) Pub. No.: US 2025/0388760 A1
(43) Pub. Date: Dec. 25, 2025

(54) Carbon Black Composition, Ink Composition, Recording Method, And Recorded Matter

(71) Applicant: SEIKO EPSON CORPORATION, Tokyo (JP)

(72) Inventors: Kenta KIKUCHI, Suwa (JP); Tetsuya AOYAMA, Shiojiri (JP); Keisuke MORITA, Shiojiri (JP); Yukimasa ISHIDA, Shiojiri (JP)

(21) Appl. No.: 19/241,656

(22) Filed: Jun. 18, 2025

(30) Foreign Application Priority Data
Jun. 20, 2024 (JP) 2024-099289

(51) Int. Cl. C09C 3/06; C08K 5/1545; C09C 1/56; C09C 3/10; C09D 11/326

(52) U.S. Cl. CPC C09C 3/063; C08K 5/1545; C09C 1/565; C09C 3/10; C09D 11/326; C01P 2004/64; C01P 2006/19; C01P 2006/22

(57) ABSTRACT

Provided is a carbon black composition for coloring containing carbon black and fulvic acid, wherein the carbon black contains a hydrophilic functional group.

The present application is based on, and claims priority from JP Application Serial Number 2024-099289, filed Jun. 20, 2024, the disclosure of which is hereby incorporated by reference herein in its entirety.

### BACKGROUND

### 1. Technical Field

The present disclosure relates to a carbon black composition, an ink composition, a recording method, and a recorded matter.

### 2. Related Art

Ink jet recording methods can record high-definition images with relatively simple apparatuses and are being rapidly developed in various fields. In recent years, there has been a concern about environmental issues, and inks have been developed in consideration of environmental issues by using materials derived from natural products. For example, JP-A-2022-167623 discloses an ink jet ink composition containing water, a plant-derived carbonized coloring material and a lignin resin for the purpose of providing an ink composition having excellent ejection reliability such as redispersibility and clogging recoverability while obtaining excellent coloring properties.

Regarding carbon black used as a coloring material, there is still room for improvement in the storage stability of the carbon black.

### SUMMARY

A carbon black composition for coloring of the present disclosure contains carbon black and fulvic acid, wherein the carbon black has a hydrophilic functional group.

An ink composition of the present disclosure contains the carbon black composition.

A recording method of the present disclosure includes a step of attaching the ink to a recording medium.

A recorded matter of the present disclosure includes the ink composition adhering to a recording medium.

### BRIEF DESCRIPTION OF THE DRAWINGS

FIG. 1 is Table 1 showing the compositions of respective compositions used in Examples and the evaluation results thereof.

FIG. 2 is Table 2 showing the compositions of respective compositions used in Examples and the evaluation results thereof.

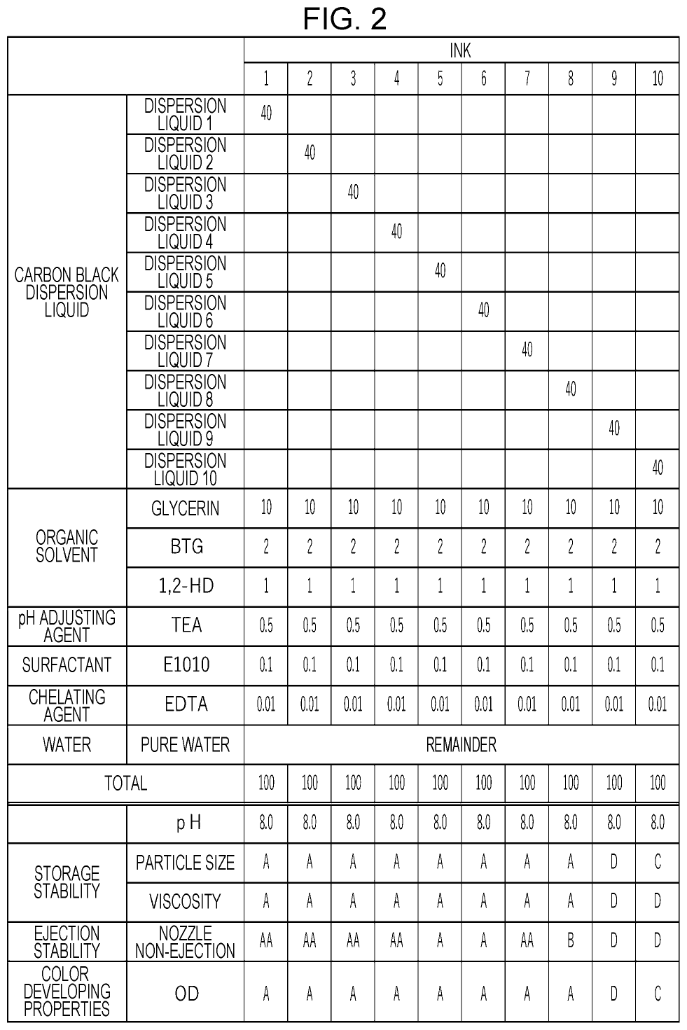

FIG. 3 is diagram illustrating an example of a recording apparatus used in a recording method according to the present embodiment.

### DESCRIPTION OF EMBODIMENTS

An embodiment of the present disclosure (hereinafter referred to as “the present embodiment”) will be described below in detail with reference to the drawings as necessary, but the present disclosure is not limited thereto, and various modifications can be made without departing from the gist thereof. In the drawings, the same elements are denoted by the same reference numerals, and redundant descriptions will be omitted. In addition, positional relationships such as up, down, left, and right are based on the positional relationships shown in the drawings unless otherwise specified. Furthermore, the dimensional ratios in the drawings are not limited to the ratios shown in the drawings.

### 1. Carbon Black Composition

The carbon black composition for coloring according to the present embodiment contains carbon black and fulvic acid, and the carbon black has a hydrophilic functional group.

Carbon black itself is not excellent in storage stability, and aggregation proceeds with time to increase the particle size or increase the viscosity. Therefore, there is still room for improvement in the storage stability of carbon black.

In recent years, environmentally friendly carbon black, such as carbon black derived from biomass and carbon black derived from recycled raw materials, has been attracting attention. In particular, the storage stability of such carbon black still has room for improvement.

Therefore, in the present embodiment, a carbon black composition for coloring having excellent storage stability is provided by using carbon black having a hydrophilic functional group and fulvic acid.

In the present embodiment, the hydrophilic functional group of the carbon black contributes to improvement in affinity with fulvic acid, and promotes adhesion and adsorption of fulvic acid to the surface of the carbon black. Meanwhile, on the surface of the carbon black, fulvic acid can function as a dispersion aid for the carbon black. More specifically, it is considered that fulvic acid functions as a surface coating material in the vicinity of the surface of the carbon black, thus making it possible to inhibit the primary particles or the secondary particles of the carbon black from further aggregating and coarsening. In addition, it is considered that impurities can be inhibited from adhering to the carbon black.

Further, also excellent are the storage stability of an ink prepared using the carbon black composition, the color developing properties of an image recorded with the ink, and particularly ejection stability when used as an ink jet ink. However, the effect of improving the storage stability by fulvic acid is not limited to the above.

The carbon black composition according to the present embodiment may be, for example, a dispersion liquid in which carbon black is dispersed in a dispersion medium, a powdery composition, a pasty composition, or the like.

In the case of the dispersion liquid, for example, it can be used for preparing inks or the like.

The carbon black composition may be used as a raw material for imparting a coloring function to a composition such as an ink, a coating material, or a toner, or can also be used as a coloring agent that is mixed with a plastic material or the like to color the plastic material itself. This is a composition for imparting a color such as black by the carbon black to these. That is, the carbon black is a pigment that functions as a coloring agent.

Components that can be contained in the carbon black composition according to the present embodiment and a production method thereof will be described below in detail.

### 1.1. Carbon Black

For the carbon black in the present embodiment, one having a hydrophilic functional group is used. When the carbon black has the hydrophilic functional group, affinity with fulvic acid is improved, and fulvic acid is easily adsorbed on the surface of the carbon black. The carbon black is not particularly limited, and examples thereof include carbon black derived from petroleum, carbon black derived from biomass, and carbon black derived from recycling.

Examples of the carbon black derived from petroleum include carbon blacks (C.I. Pigment Black 7) such as furnace black, lamp black, acetylene black, and channel black.

The carbon black derived from biomass is not particularly limited, and examples thereof include plant coals obtained by carbonizing plants, such as Binchotan charcoal, bamboo charcoal, activated charcoal, white charcoal, black charcoal, molded charcoal, sawdust charcoal, plum charcoal, activated charcoal, oak charcoal, Douglas-fir charcoal, seaweed charcoal, mangrove charcoal, and coconut shell charcoal.

Vegetable oil carbon black obtained by carbonizing vegetable oil can also be used. Examples of the vegetable oil carbon black include carbon black obtained by subjecting vegetable oil to incomplete combustion or a thermal decomposition reaction at a high temperature and carbon black obtained by recovering smoke generated by burning vegetable oil (lamp black using vegetable oil as a raw material).

It is also possible to use oil soot, pine soot, or the like, which is used for black ink. Among these, carbon black obtained from inedible plants is preferably used.

The carbon black may have a structure such as a crystal structure, an amorphous structure, or a graphite structure.

Among these, the biomass-derived carbon black and recycling-derived carbon black derived from are preferable from the viewpoint of reducing environmental load. On the other hand, however, in particular, the biomass-derived carbon black and the recycling-derived carbon black contain complicated impurities and tend to have a complicated structure. Due to such impurities and the complexity of the structure, the storage stability tends to be relatively poor.

In addition, depending on the kind of the carbon black derived from biomass or the carbon black derived from recycling, the content of impurities tends to be large. Therefore, the storage stability tends to be poor.

Therefore, there is a concern that characteristics such as the storage stability of an ink containing the carbon black derived from biomass, the color developing properties of an image recorded with the ink, and ejection stability when used as an ink jet ink are not necessarily sufficient.

The present disclosure is particularly useful for such carbon black.

“Structure” is a term meaning the connection of particles and the size of the particles, such as how the fine particles of the carbon black are aggregated and what shape and arrangement the fine particles take, and means, for example, a state of primary particles, secondary particles, in which primary particles are aggregated, or the like.

Examples of the hydrophilic functional group include an ionic group and a hydroxy group. Examples of the ionic group include an acidic group and a basic group. Such an ionic group is not particularly limited, and examples thereof include a carboxy group, an amino group, a sulfo group, and a phosphorus-containing acid group. Examples of the phosphorus-containing acid group include a phosphoric acid group and a phosphonic acid group. An acidic group is preferable.

In the case where the hydrophilic functional group is an ionic group, the ionic group may be in the form of a salt or may be in the form of an ion, which are included in the ionic group.

Among these, the hydrophilic functional group preferably contains at least one of a hydroxy group and an acidic group. The acidic group is preferably a carboxy group. Therefore, the hydrophilic functional group preferably contains at least one of a hydroxy group and a carboxy group. When the hydrophilic functional group contains at least one of a hydroxy group and a carboxy group, the storage stability tends to be further improved.

The hydrophilic functional group may be introduced into carbon black by, for example, oxidation treatment or chemical reaction with a compound such as a treatment agent, or carbon black having a hydrophilic functional group may be directly obtained and used. For example, the hydroxy group or the carboxy group may be introduced by subjecting carbon black to oxidation treatment in the presence of an oxidizing agent such as sodium hypochlorite. At this time, the introduction ratio of the hydroxy group or the carboxy group may be adjusted by adjusting the degree of the oxidation treatment. In addition, other ionic groups may be introduced by reacting a treatment agent having any ionic group with the hydroxy group or the carboxy group thus introduced.

The DBP oil absorption amount of the carbon black of the present embodiment is preferably 50 to 200 mL/100 g, 70 to 180 mL/100 g, 80 to 150 mL/100 g, or 90 to 130 mL/100 g. When the DBP oil absorption amount is within the above range, the storage stability tends to be further improved.

The DBP oil absorption amount is a value expressed as the amount of dibutyl phthalate (DBP) absorbed by carbon black in an amount of 100 g, and can be determined in accordance with the measurement method specified in JIS K6221. In general, the more the structure of carbon black is developed, the larger the DBP oil absorption amount.

The average particle size of the primary particles of the carbon black of the present embodiment is preferably 10 to 50 nm, 15 to 45 nm, 20 to 40 nm, or 25 to 35 nm. When the average particle diameter of the primary particles is within the above range, the storage stability tends to be further improved. The primary particle size of the carbon black can be determined as an arithmetic average size by observing carbon black particles with an electron microscope.

The DBP oil absorption amount and the average particle size of the primary particles of the carbon black can be adjusted by, for example, adjusting the concentration of a raw material oil and heating conditions such as a heating temperature when the carbon black is produced.

A content A of the carbon black is preferably 0.1 to 25% by mass, 5 to 22% by mass, 10 to 20% by mass, or 12 to 18% by mass with respect to the total amount of the carbon black composition. When the content A of the carbon black is within the above range, the storage stability tends to be further improved.

The carbon black may be a self-dispersible pigment or a resin-dispersed pigment.

The self-dispersible pigment is a pigment that can be dispersed in an aqueous medium without a dispersant. Examples of such a self-dispersible pigment include a pigment in which a hydrophilic functional group or the like is directly introduced to the pigment surface by performing a physical or chemical surface treatment to be dispersed in a solvent. The hydrophilic functional group in the self-dispersible pigment preferably contains an acidic group such as a carboxy group. When the carbon black is a self-dispersible pigment, fulvic acid easily adheres to the carbon black, and the storage stability is further improved, which is preferable.

The resin-dispersed pigment is a pigment dispersed with a resin. The resin-dispersed pigment may be a pigment obtained through a step of dispersing carbon black with a resin dispersant as a resin, or a pigment dispersed through a step of coating the surface of carbon black with a resin to encapsulate the carbon black. When the carbon black as the resin-dispersed pigment has a hydrophilic functional group, the affinity of the resin for the carbon black is improved, the resin tends to adhere or be adsorbed easily, and the storage stability is further improved, which is preferable.

The dispersion with the resin dispersant is preferably carried out by mixing the carbon black and fulvic acid and then dispersing the mixture with the resin. The carbon black may be dispersed with the resin, and then fulvic acid may be mixed. When fulvic acid adheres to a portion of the carbon black that is not covered with the dispersant, the storage stability of the carbon black tends to be further improved. The resin is not particularly limited, and for example, a known resin in the related art can be used.

1.1.1. Carbon Black Derived from Biomass

The carbon black of the present embodiment preferably contains the carbon black derived from biomass. As used herein, the term “raw material derived from biomass” refers to not a raw material derived from fossil fuels such as petroleum and coal, but a raw material derived from organisms such as plants, animals, and microorganisms. The raw material derived from biomass is derived from living organisms.

By using the carbon black derived from biomass, components derived from petroleum contained in the ink can be reduced. As a result, the amount of carbon dioxide emission can be reduced as compared with the case where components derived from petroleum are used, and an environmentally friendly ink can be obtained. Further, the carbon black derived from biomass contains a large amount of impurities and tends to easily generate fulvic acid by oxidation treatment. The raw material of the carbon black derived from biomass is not particularly limited, and examples thereof include vegetable oil and vegetable oil charcoal. In addition, the storage stability tends to be a problem due to a large amount of impurities, a complex and large structure, and the like, but the storage stability is obtained by fulvic acid, and thus the present disclosure is particularly useful.

The vegetable oil carbon black is produced by carbonizing vegetable oil into carbon black, and has a production process similar to that of petroleum carbon black in that liquid is burned and carbonized, and is relatively easy to produce. Since the amount of impurities is relatively easily reduced by refining a liquid raw material, impurities can be inhibited from adhering to the carbon black, and the storage stability is further improved.

1.1.2. Carbon Black Derived from Recycled Raw Materials

The carbon black of the present embodiment preferably contains the carbon black derived from recycled raw materials. By using recycled raw materials, the amount of components derived from petroleum can be reduced, and the amount of carbon dioxide emission can be reduced as compared with the case where components derived from petroleum are used. Thus, an environmentally friendly ink can be obtained. The carbon black derived from recycled raw materials is carbon black obtained by thermally decomposing waste such as waste tires. The carbon black derived from recycled raw materials contains a large amount of impurities and tends to easily generate fulvic acid by oxidation treatment, similarly to the carbon black derived from biomass. In addition, the storage stability tends to be a problem due to a large amount of impurities, a complex and large structure, and the like, and thus the present disclosure is particularly useful.

### 1.2. Fulvic Acid

The carbon black composition in the present embodiment contains fulvic acid. It is thought that fulvic acid can function as a dispersion aid for the carbon black. More specifically, it is considered that fulvic acid functions as a surface coating material in the vicinity of the surface of the carbon black, thus making it possible to inhibit the primary particles or the secondary particles of the carbon black from further aggregating and coarsening. In addition, it is considered that impurities can be inhibited from adhering to the carbon black. However, the effect of improving the storage stability by fulvic acid is not limited to the above. In the present embodiment, fulvic acid does not correspond to the resin dispersant.

Fulvic acid is a general term for a group of acid-type substances that are not precipitated by an acid among substances contained in corrosive substances. Fulvic acid can be obtained by separation and purification from soil using an acid or an alkali, and is also available as a commercial product. Fulvic acid is also produced in the process of subjecting carbon black to oxidation treatment such as self-dispersion. Since fulvic acid thus obtained has high water solubility and low pH dependency, it can maintain water solubility in a wide pH range and is less likely to become a foreign substance even when the pH changes. That is, even when a change in the state of the ink composition occurs, it can function usefully as a dispersion aid. Therefore, the storage stability and the like are excellent.

In addition, properties such as the storage stability of an ink containing carbon black, the color developing properties of an image recorded with the ink, and ejection stability when used as an ink jet ink also tend to be excellent.

Fulvic acid may be in the form of fulvate.

In the present embodiment, separately prepared fulvic acid may be mixed to prepare a composition, or fulvic acid separated from a treated liquid secondarily produced during the oxidation treatment of the carbon black derived from biomass may be used after concentration, dilution, or the like.

Fulvic acid preferably has a peak at an emission wavelength (EM) of 380 to 600 nm and an excitation wavelength (EX) of 180 to 320 nm in an excitation-emission matrix analysis method. That is, fulvic acid preferably has a peak in the range of the excitation wavelength (EX) corresponding to the range of the emission wavelength (EM).

Further, in the excitation-emission matrix analysis method, fulvic acid preferably has a peak at an emission wavelength (EM) of 400 to 600 nm and an excitation wavelength (EX) of 200 to 300 nm.

Fulvic acid produced when carbon black is subjected to oxidation treatment has a peak of the emission wavelength and the excitation wavelength within the above ranges. Such fulvic acid has a carbon skeleton similar to that of the carbon black, has high affinity for the carbon black, and easily exhibits a dispersion stabilizing effect. Therefore, the storage stability tends to be further improved.

The peak position of the emission wavelength of the fulvic acid of the present embodiment in the excitation-emission matrix analysis method is preferably 400 to 550 nm, 400 to 500 nm, 420 to 480 nm, or 430 to 460 nm. When the emission wavelength of fulvic acid is within the above range, the storage stability tends to be further improved.

The peak position of the excitation wavelength of the fulvic acid of the present embodiment in the excited-emission matrix analysis method is preferably 200 to 320 nm, 200 to 300 nm, 220 to 280 nm, or 240 to 270 nm. When the excitation wavelength of fulvic acid is within the above range, the storage stability tends to be further improved.

The number of peaks with the emission wavelength and the excitation wavelength of fulvic acid in the excitation-emission matrix analysis method being in the above ranges may be one or more or 1 to 5, for example. Further, the number may be 2 or 3. When fulvic acid has a plurality of peaks, at least one of the peaks preferably satisfies the above wavelength regions. It is more preferable that all the peaks satisfy the above wavelength regions. That is, it is more preferable not to have a peak that does not satisfy the above wavelength regions.

A content B of fulvic acid is preferably 0.015 to 15% by mass, 0.03 to 10% by mass, 0.05 to 8% by mass, 0.07 to 6% by mass, or 0.1 to 3% by mass with respect to the total amount of the carbon black composition. When the content B of fulvic acid is within the above range, the storage stability tends to be further improved.

The mass ratio (B/A) of the content B of fulvic acid to the content A of the carbon black is preferably 0.0001 to 0.5, 0.001 to 0.5, 0.005 to 0.3, or 0.01 to 0.1. When the mass ratio of the content B of fulvic acid to the content A of the carbon black is within the above range, the storage stability tends to be further improved.

### 1.3. Organic Solvent

The carbon black composition in the present embodiment may contain an organic solvent. Examples of the organic solvent include polyols and glycol ethers. One kind of the organic solvent may be used alone, or two or more kinds thereof may be used in combination. Examples of polyols include diethylene glycol, propylene glycol, and glycerin. One kind of the organic solvent may be used alone, or two or more kinds thereof may be used in combination.

The content of the organic solvent is preferably 0.1 to 15% by mass, 1 to 10% by mass, 1.5 to 8% by mass, or 2 to 5% by mass with respect to the total amount of the carbon black composition. When the content of the organic solvent is within the above range, the storage stability tends to be further improved.

1.4. pH-Adjusting Agent

The carbon black composition may contain a pH adjusting agent as necessary. Examples of the pH-adjusting agent include inorganic acids (e.g., sulfuric acid, hydrochloric acid, nitric acid, and the like), inorganic bases (e.g., lithium hydroxide, sodium hydroxide, potassium hydroxide, ammonia, and the like), organic acids (e.g., adipic acid, citric acid, succinic acid, and the like), organic bases (triethanolamine, diethanolamine, monoethanolamine, triisopropanolamine, diisopropanolamine, and trishydroxymethylaminomethane). One kind of the pH adjusting agent may be used alone, or two or more kinds thereof may be used in combination.

### 1.5 Water

The carbon black composition in the present embodiment may be a pigment dispersion liquid containing a dispersion medium containing water, and the carbon black is dispersed in the dispersion medium. That is, the dispersion medium contains at least water as its main component.

Since fulvic acid has high water solubility, the effect of improving the storage stability is more significant in the carbon black dispersion liquid containing the dispersion medium containing water. A pigment dispersion containing at least water as the main component of the dispersion medium is also referred to as an aqueous pigment dispersion.

The content of water is preferably 30% by mass or more, more preferably 40% by mass or more, and even more preferably 50% by mass or more with respect to the total amount of the carbon black composition. Furthermore, the content is preferably 60 to 95% by mass, 65 to 90% by mass, 70 to 85% by mass %, or 75 to 83% by mass. When the content of water is within the above range, the storage stability tends to be further improved.

### 1.6. Other Components

The carbon black composition may contain components other than the components described above. As the other components, various additives such as a dissolution aid, a viscosity modifier, an antioxidant, a preservative, a fungicide, and a corrosion inhibitor can be added as appropriate.

### 2. Ink Composition

The ink composition in the present embodiment contains the carbon black composition. If necessary, other components may be further contained.

By containing the carbon black composition, the storage stability and the ejection stability are improved. The ink composition is not particularly limited, and may be an ink jet ink composition. Alternatively, the ink composition may be various inks such as an ink for analog printing and an ink for writing tools.

The content of the carbon black in the ink composition is preferably 0.1 to 20% by mass, 1 to 15% by mass, 3 to 10% by mass, or 5 to 8% by mass with respect to the total amount of the ink composition. When the content of the carbon black is within the above range, the ejection stability, the color developing properties, and the like are more excellent, which is preferable.

The content of fulvic acid in the ink composition is preferably 0.005 to 5% by mass, 0.01 to 1% by mass, 0.03 to 0.5% by mass, 0.05 to 0.2% by mass, or 0.03 to 0.1% by mass with respect to the total amount of the ink composition. When the content of fulvic acid is within the above range, the ejection stability and the like are more excellent, which is preferable.

### 2.1. Organic Solvent

The ink composition in the present embodiment may contain an organic solvent. Examples of the organic solvent include polyols and glycol ethers. One kind of the organic solvent may be used alone, or two or more kinds thereof may be used in combination. Examples of polyols include diethylene glycols, 1,2-hexanediol, propylene glycol, and glycerin. Glycol ethers may be monoethers or diethers of alkylene glycols, and examples thereof include ethylene glycol monomethyl ether and triethylene glycol monobutyl ether.

The content of the organic solvent is preferably 1 to 20% by mass, 5 to 18% by mass, 7 to 16% by mass, or 10 to 15% by mass % with respect to the total amount of the ink composition. When the content of the organic solvent is within the above range, the storage stability and the ejection stability tend to be further improved.

### 2.2. Surfactant

The ink composition in the present embodiment may contain a surfactant. Examples of the surfactant include silicone-based surfactants, acetylene glycol-based surfactants, and fluorine-based surfactants. One kind of the surfactant may be used alone, or two or more kinds thereof may be used in combination.

Commercially available products of acetylene glycol-based surfactants are not particularly limited, and examples thereof include E1010 and EXP4200 (manufactured by Nissin Chemical Co., Ltd.).

The content of the surfactant is preferably 0.01 to 1.5% by mass, 0.05 to 1% by mass, 0.07 to 0.8% by mass, or 0.1 to 0.5% by mass with respect to the total amount of the ink composition. When the content of the surfactant is within the above range, the storage stability and the ejection stability tend to be further improved.

2.3. pH-Adjusting Agent

The ink composition in the present embodiment may contain a pH adjusting agent as necessary. Examples of the pH-adjusting agent include inorganic acids (e.g., sulfuric acid, hydrochloric acid, nitric acid, and the like), inorganic bases (e.g., lithium hydroxide, sodium hydroxide, potassium hydroxide, ammonia, and the like), organic acids (e.g., adipic acid, citric acid, succinic acid, and the like), organic bases (triethanolamine, diethanolamine, monoethanolamine, triisopropanolamine, diisopropanolamine, and trishydroxymethylaminomethane). One kind of the pH adjusting agent may be used alone, or two or more kinds thereof may be used in combination.

### 2.4. Chelating Agent

The ink composition in the present embodiment may contain a chelating agent as necessary. When the ink composition contains the chelating agent, the storage stability tends to be further improved. The chelating agent is not particularly limited, and examples thereof include ethylenediaminetetraacetic acid salt (EDTA), edetate disalt, pyrophosphate, hexametaphosphate, citric acid, tartaric acid, and gluconic acid. One kind of the chelating agent may be used alone, or two or more kinds thereof may be used in combination.

### 2.5. Water

The ink composition of the present embodiment may contain water as necessary. An aqueous ink composition containing at least water as its solvent component is preferable.

The content of water is preferably 50% by mass or more, 60 to 98% by mass, 70 to 95% by mass, 75 to 90% by mass, or 77 to 85% by mass with respect to the total amount of the ink. When the content of water is within the above range, the storage stability and the ejection stability tend to be excellent.

### 2.6. Other Components

The ink composition may contain components other than the components described above. As the other components, various additives such as a dissolution aid, a viscosity modifier, an antioxidant, a preservative, a fungicide, and a corrosion inhibitor can be added as appropriate.

The content of each of the other components is preferably 0 to 10% by mass, 0 to 5% by mass, or 0 to 3% by mass with respect to the total amount of the ink composition.

### 3. Recording Method

The recording method according to the present embodiment includes a step of attaching the ink composition to a recording medium. The recording method may be an ink jet recording method performed by an ink jet method, which is preferable.

The ink jet recording method according to the present embodiment includes a step of, using a certain ink jet head, ejecting the ink jet ink composition from the ink jet head to attach the ink jet ink composition to a recording medium. In addition, the ink jet recording method may further include a transporting step of transporting the recording medium, and the attaching step and the transporting step may be performed at the same time.

### 4. Recording Apparatus

The recording apparatus according to the present embodiment is a recording apparatus performing recording using the ink composition. The recording apparatus may be an ink jet recording apparatus performing recording by an ink jet method, which is preferable.

The ink jet recording apparatus of the present embodiment includes the ink composition described above, and an ink jet head having a nozzle ejecting the ink composition described above onto a recording medium, and preferably further includes a supply flow path circulating the ink composition described above and is connected to the ink jet head, and a filter unit provided in the supply flow path of the ink jet head.

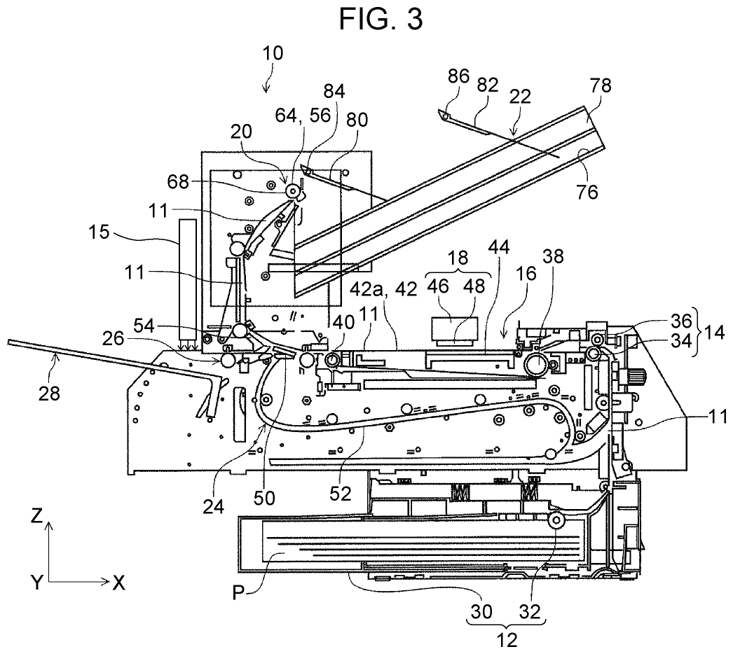

FIG. 3 illustrates an example of the ink jet recording apparatus as an example of a recording apparatus that can be used in the present embodiment. The ink jet recording apparatus according to the present embodiment will be described in more detail with reference to FIG. 3. In an X-Y-Z coordinate system illustrated in FIG. 3, the X direction indicates the length direction of a recording medium, the Y direction indicates the width direction of the recording medium in a transport path in the recording apparatus, and the Z direction indicates an apparatus height direction.

A recording apparatus 10 is, as an example, a line type ink jet printer capable of performing high-speed and high-density printing. The recording apparatus 10 includes a feeding section 12 storing a recording medium P such as paper, a transport section 14, a belt transport section 16, a recording section 8, a face-down (Fd) discharge section 20 as “discharge section,” a face-down (Fd) mounting section 22 as “mounting section, “an inverted path section 24 as “inverted transport mechanism,” a face-up (Fu) discharge section 26, and a face-up (Fu) mounting section 28.

The feeding section 12 is disposed in a lower portion of the recording apparatus 10. The feeding section 12 includes a feeding tray 30 storing the recording medium P and a feeding roller 32 feeding the recording medium P stored in the feeding tray 30 to a transport path 11.

The recording medium P stored in the feeding tray 30 is fed to the transport section 14 along the transport path 11 by the feeding roller 32. The transport section 14 includes a transport driving roller 34 and a transport driven roller 36. The transport driving roller 34 is rotationally driven by a drive source (not shown). In the transport section 14, the recording medium P is nipped between the transport driving roller 34 and the transport driven roller 36 and transported to the belt transport section 16 positioned on the downstream side of the transport path 11.

The belt transport section 16 includes a first roller 38 positioned on the upstream side in the transport path 11, a second roller 40 positioned on the downstream side, an endless belt 42 mounted on the first roller 38 and the second roller 40 in a rotationally movable manner, and a support 44 supporting an upper section 42a of the endless belt 42 between the first roller 38 and the second roller 40.

The endless belt 42 is driven to move from the +X direction to the −X direction in the upper section 42a by the first roller 38 or the second roller 40 driven by a drive source (not shown). Therefore, the recording medium P transported from the transport section 14 is further transported to the downstream side of the transport path 11 in the belt transport section 16.

The recording section 8 includes a line type ink jet head 48 and a head holder 46 holding the ink jet head 48. The recording section 8 may be of a serial type one, in which an ink jet head is provided on a carriage reciprocating in the Y-axis direction. The ink jet head 48 is disposed so as to face the upper section 42a of the endless belt 42 supported by the support 44. When the recording medium P is transported in the upper section 42a of the endless belt 42, the ink jet head 48 ejects ink toward the recording medium P to execute recording. The recording medium P is transported to the downstream side of the transport path 11 by the belt transport section 16 while recording is performed thereon.

A first branch section 50 is provided on the downstream side of the transport path 11 of the belt transport section 16. The first branch section 50 is configured to be switchable between the transport path 11 for transporting the recording medium P to the Fd discharge section 20 or the Fu discharge section 26 and an inverted path 52 of the inverted path section 24 for inverting the recording surface of the recording medium P to transport the recording medium P again to the recording section 8. The recording surface of the recording medium P, which is switched to the inverted path 52 by the first branch section 50 to be transported, is inverted in a transport process in the inverted path 52, and the recording medium P is transported again to the recording section 8 such that the surface opposite to the initial recording surface faces the ink jet head 48.

A second branch section 54 is further provided on the downstream side of the first branch section 50 along the transport path 11. The second branch section 54 is configured to be capable of switching the transport direction of the recording medium P so as to transport the recording medium P toward the Fd discharge section 20 or transport the recording medium P toward the Fu discharge section 26.

The recording medium P transported toward the Fd discharge section 20 in the second branch section 54 is discharged from the Fd discharge section 20 to be mounted on the Fd mounting section 22. At this time, the recording medium P is mounted such that the recording surface thereof faces the Fd mounting section 22. Further, the recording medium P transported toward the Fu discharge section 26 in the second branch section 54 is discharged from the Fu discharge section 26 to be mounted on the Fu mounting section 28. At this time, the recording medium P is mounted such that the recording surface thereof faces the side opposite to the Fu mounting section 28.

### 5. Recording Medium

The recording medium used in the present embodiment is not particularly limited, and examples thereof include an absorbent recording medium, a low-absorbent recording medium, and a non-absorbent recording medium, and the absorbent recording medium is preferable.

Examples of the absorbent recording medium include plain paper such as electrophotographic paper having high ink permeability, and ink jet paper (ink jet dedicated paper including an ink absorbing layer formed of silica particles or alumina particles or an ink absorbing layer formed of a hydrophilic polymer such as polyvinyl alcohol (PVA) or polyvinylpyrrolidone (PVP)).

Examples of the low-absorbent recording medium include art paper, coated paper, and cast paper, which have relatively low ink permeability and are used for general offset printing.

Examples of the non-absorbent recording medium include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates or plastic films produced by evaporation of these various metals, and plates of alloys such as stainless and brass; and recording media obtained by bonding (applying) a film of plastics such as polyvinyl chloride, polyethylene, polypropylene, polyethylene terephthalate (PET), polycarbonate, polystyrene, and polyurethane to a paper substrate.

### 6. Recorded Matter

The recorded matter of the present embodiment is obtained by attaching the ink composition described above to a recording medium. The recorded matter of the present embodiment using the ink composition described above can be recorded with an ink having excellent storage stability and ejection stability. In addition, by using the ink composition containing the carbon black derived from biomass or the carbon black derived from recycled raw materials, it is possible to perform recording with an ink having excellent storage stability and ejection stability while considering the environment.

### EXAMPLES

The present disclosure will be described below more specifically with reference to Examples and Comparative Examples. The present disclosure is not limited by Examples below in any way.

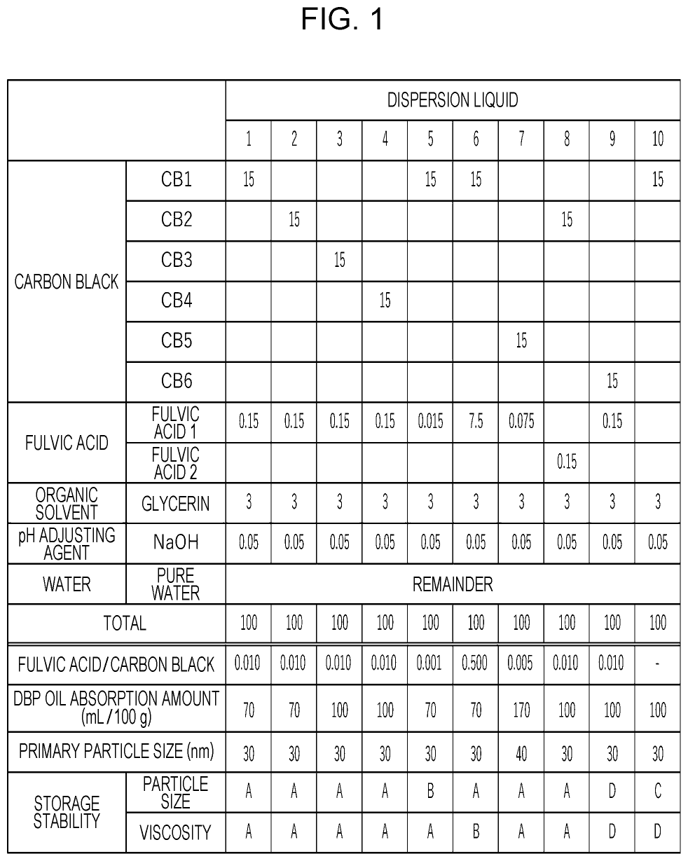

FIG. 1 shows Table 1 showing the compositions of the respective ink compositions of Examples and Comparative Examples and the evaluation results thereof.

### 1. Preparation of Carbon Black Composition

Mixing and stirring were preformed to prepare a dispersion liquid so as to have the composition shown in Table 1 to obtain a carbon black composition of each example. The numerical value of each component shown in each example in the table represents % by mass unless otherwise specified. Further, in the table, each numerical value represents % by mass of the solid content of the component.

Details of the product components used in Tables 1 and 2 are as follows.

### Carbon Black

CB1 to CB6 (see preparation examples below)

### Fulvic Acid

Fulvic acid 1 (see a preparation example below)
Fulvic acid 2 (manufactured by Royal Industries Co., Ltd., Royal Fulvic Acid)

### Organic Solvent

Glycerin (manufactured by Kanto Chemical Co., Inc.)

### pH Adjusting Agent

NaOH (sodium hydroxide)

The carbon black was prepared by being processed as described below. The content of each carbon black in Table 1 and Table 2 is the solid content of each carbon black.

### Preparation Example of CB1

### Washing Step

Carbon black in an amount of 25 g (PRINTEX Nature, plant oil carbon black available from Orion Engineered Carbons S.A.) was stirred and washed with toluene to wash off substances such as unburned components adhering to the surfaces of the carbon black.

### Surface Treatment Step

To the carbon black after the washing step, 5 g of sodium hypochlorite was added in water, and the mixture was subjected to ultrasonic treatment to perform a surface treatment reaction.

### Dispersion Step

The dispersion liquid of the carbon black after the surface treatment step was subjected to dispersion treatment for 1 hour with 0.3 mm beads using a rocking mill to obtain a slurry. Next, 20% by mass of sodium hypochlorite was added to the carbon black in the slurry, and the mixture was heated to 70° C. to perform a surface treatment reaction for 30 minutes. The particle size was measured, and when the particle size did not reach a target particle size, the dispersion treatment and the surface treatment were performed again. Since a new hydrophobic surface was formed on the carbon black by the dispersion, the surface treatment reaction was performed also in the dispersion step.

### Neutralization and Purification Step

NaOH was added to the dispersion liquid of the carbon black after the dispersion step, and the dispersion liquid was neutralized to a pH of 8 to 9 suitable for an ink. After the neutralization reaction, the dispersion liquid was cooled to room temperature, solid-liquid separation was performed using a centrifugal separator or the like to perform desalination treatment. The solid was then recovered and dried at 100° C. As a result, CB1, which was carbon black having carboxy groups introduced on the surfaces thereof by the surface treatment, was obtained.

### Preparation Example of CB2

After preparing CB1, CB1 and Hiros X220 (styrene-maleic acid-based resin dispersant, Seiko PMC Corporation) were mixed in water at a mass ratio of 4:1 in terms of effective components, and the mixture was stirred with a bead mill to obtain CB2 as a resin-dispersed pigment.

### Preparation Example of CB3

CB3 surface-treated to have carboxy groups introduced on the surfaces thereof was obtained in the same manner as in CB1 except that #30 (carbon black derived from petroleum) manufactured by Mitsubishi Chemical Corporation was used as the carbon black.

### Preparation Example of CB4

CB4 surface-treated to have carboxy groups introduced on the surfaces thereof was obtained in the same manner as in CB2 except that Printex 30 (carbon black derived from petroleum) manufactured by Orion Engineered Carbons S.A. was used as the carbon black.

### Preparation Example of CB5

CB5 surface-treated to have carboxy groups introduced on the surfaces thereof was obtained in the same manner as in CB1 except that TOKA BLACK #4500 (carbon black derived from petroleum) manufactured by Tokai Carbon Co., Ltd. was used as the carbon black.

### Preparation Example of CB6

CB6 was obtained in the same manner as in CB1 except that the surface treatment step was not performed, and the surface treatment reaction was not performed in the dispersion step, either. Since the surface treatment step and the like were not performed, CB6 was carbon black not having carboxy groups introduced on the surfaces.

### Preparation Example of Fulvic Acid 1

In the surface treatment step of CB1, the waste liquid after washing was recovered, insoluble matter (humus) generated by adding an alkali aqueous solution to the waste liquid and a liquid were separated, an acid aqueous solution was further added to the liquid obtained by the separation to separate the generated insoluble matter and the liquid, and the liquid obtained by the separation was concentrated and purified to obtain fulvic acid 1. Fulvic acid is fulvic acid including one in the form of fulvate.

### Preparation Example of Fulvic Acid 2

In the preparation of fulvic acid 1, an aqueous solution of fulvic acid 2 was used instead of the waste liquid, and the same treatment was performed.

### 1.1. DBP Oil Absorption Amount

The carbon black prepared as described above in an amount of 25 g was weighed and charged into a sample vessel, and then the sample vessel was heated and maintained at 100° C. to remove water. Next, the carbon black was charged into AbsorptoMeter, dibutyl phthalate (DBP) was charged as an oil into an automatic burette device, and then dropwise addition of dibutyl phthalate was started. The torque curve of AbsorptoMeter was recorded by writing with a pen or using a data acquisition system, and the value at 70% of the maximum torque was read off as an end point. The measurement unit was converted to mL/100 g, and the average value of two times of measurement was defined as the DBP oil absorption amount.

### 1.2 Excitation-Emission Matrix Analysis Method (EEM)

The carbon black dispersion liquid prepared as described above was subjected to a centrifugal separator (high-speed cooling centrifuge Suprema 21, manufactured by Tomy Seiko Co., Ltd.), and the carbon black was precipitated under separation conditions of 20° C., 12,000 rpm, and 120 min. When fine particles remained in the supernatant, magnesium sulfate in an amount of 0.1% to 0.5% with respect to the charged carbon black was added to aggregate the particles, and the particles were again precipitated with the centrifugal separator. Then the carbon black was removed, and the supernatant was used as a measurement sample.

The obtained measurement sample was diluted 1,000 times with pure water, and the excitation wavelength (Ex) was three-dimensionally measured by a lateral reflection method under the following conditions. When the prepared measurement sample was dense, a surface reflection method can also be selected.
Holder: a holder for liquids (a lateral photometric system) or a holder for solids (a surface photometric system)
Cell: surface-polished quartz cell (a 10×10 mm square quartz cell, lateral photometry) or a two-sided polished quartz cell (a 20×10 mm quartz cell, surface photometry).
Measurement wavelength for excitation (Ex): 200 to 700 nm
Measurement wavelength for emission (Em): 200 to 700 nm
Data interval for excitation (Ex): 5.0 nm
Data interval for emission (Em): 5.0 nm
Scan speed: 60,000 nm/min
Slit width excitation (Ex): 5.0 nm
Slit width emission (Em): 5.0 nm
Sensitivity: a photomultiplier voltage of 700 V Response: 2 ms
Automatic filter control: ON (automatic high-order light cut)

As a measurement result of the excitation-emission matrix analysis method, fulvic acid 1 had two peaks of a peak at an excitation wavelength of 260 nm and an emission wavelength of 445 nm and a peak at an excitation wavelength of 265 nm and an emission wavelength of 430 nm.

Fulvic acid 2 had two peaks of a peak at an excitation wavelength of 240 nm and an emission wavelength of 540 nm and a peak at an excitation wavelength of 310 nm and an emission wavelength of 440 nm.

### 1.3. Primary Particle Size of Carbon Black

The carbon black particles were observed with an electron microscope, and the arithmetic average size was calculated to measure the primary particle size of the carbon black.

### 2. Preparation of Ink Jet Ink Composition

Each component was put into a mixture tank so as to have the composition shown in Table 2, mixed and stirred, and further filtered through a membrane filter to obtain an ink composition of each example.

### Organic Solvent

Glycerin (manufactured by Kanto Chemical Co., Inc.)
BTG (triethylene glycol monobutyl ether, manufactured by Nippon Nyukazai Co., Ltd.)
1,2-HD (1,2-hexanediol, manufactured by Toyo Gosei Co., Ltd.)

### pH Adjusting Agent

TEA (triethanolamine)

### Surfactant

E1010 (acetylene glycol-based surfactant, manufactured by Nissin Chemical Co., Ltd.)

### Chelating Agent

EDTA (ethylenediaminetetraacetic acid)

### Water

Pure water

### 3. Evaluation Methods

### 3.1. Storage Stability (Particle Size)

The dispersion liquid or the ink composition was put into a closed glass container and left to stand at 60° C. for 5 days. The dispersion liquid or the ink composition after being left to stand was taken out, and the average particle size D50 (nm) was measured with a dynamic light scattering particle size distribution analyzer (ELSZ-1000, manufactured by Otsuka Electronics Co., Ltd.). The particle sizes before and after storage were compared, and a change rate was determined to evaluate the storage stability according to the following evaluation criteria.

### Evaluation Criteria

A: the change rate being less than 10%
B: the change rate being 10% or more and less than 20%
C: the change rate being 20% or more and less than 30%
D: the change rate being 30% or more

### 3.2. Storage Stability (Viscosity)

The dispersion liquid or the ink composition was put into a closed glass container and left to stand at 60° C. for 5 days. The dispersion liquid or the ink composition after being left to stand was taken out, and the viscosity at a shear rate of 200 s⁻¹ was measured with a rheometer (MCR-306, manufactured by Anton Paar). The viscosities before and after storage were compared, and a change rate was determined to evaluate the storage stability according to the following evaluation criteria.

### Evaluation Criteria

A: the change rate being less than 10%
B: the change rate being 10% or more and less than 20%
C: the change rate being 20% or more and less than 30%
D: the change rate being 30% or more

### 3.3. Ejection Stability

The ink composition was charged into a certain ink storage container and left to stand at 60° C. for 5 days. Thereafter, the storage container was mounted on a recording apparatus (a modified machine of PX-H6000, manufactured by Seiko Epson Corporation), the ink jet ink was ejected, a solid pattern was printed on plain paper with a recording resolution of 1,440×720 dpi to evaluate the ejection stability according to the following evaluation criteria. The operating environment of the recording apparatus (printer) was set to 40° C. and 20% RH. The number of nozzles was set to 300.

### Evaluation Criteria

AA: 0 non-ejecting nozzle
A: 1 to 9 non-ejecting nozzles
B: 10 to 19 non-ejecting nozzles
C: 20 to 29 non-ejecting nozzles
D: 30 or more non-ejecting nozzles

### 3.4. Color Developing Properties (OD)

The ink composition was charged into a printer (a modified machine of PX-S840, manufactured by Seiko Epson Corporation). With A4 plain paper (Xerox P paper) used as a recording medium, a solid pattern was printed thereon at a printing Duty of 100%. After printing, the optical density (hereinafter also referred to as “OD”) of the printed matter was measured, and the color developing properties were evaluated according to the following evaluation criteria.

### Evaluation Criteria

A: OD being 1.0 or more
B: OD being 0.8 or more and less than 1.0
C: OD being 0.6 or more and less than 0.8
D: OD being less than 0.6

### 4. Evaluation Results

Table 1 shows the compositions of the carbon black dispersion liquids used in the respective examples and the evaluation results thereof. It can be seen from Table 1 that the carbon black composition containing carbon black having a hydrophilic functional group and fulvic acid is excellent in the storage stability.

Table 2 shows the compositions of the ink compositions used in the respective examples and the evaluation results thereof. It can be seen from Table 2 that the ink composition containing the carbon black composition containing carbon black having a hydrophilic functional group and fulvic acid is excellent in the storage stability and the ejection stability.

What is claimed is:

1. A carbon black composition for coloring comprising carbon black and fulvic acid, wherein
the carbon black has a hydrophilic functional group.

2. The carbon black composition according to claim 1, wherein the carbon black contains at least one of carbon black derived from biomass and carbon black derived from recycled raw materials.

3. The carbon black composition according to claim 1, wherein a DBP oil absorption amount of the carbon black is 50 to 180 mL/100 g.

4. The carbon black composition according to claim 1, wherein an average particle size of primary particles of the carbon black is 10 to 50 nm.

5. The carbon black composition according to claim 1, wherein the fulvic acid has a peak at an emission wavelength of 400 nm to 600 nm and an excitation wavelength (EX) of 200 nm to 300 nm in an excitation-emission matrix analysis method.

6. The carbon black composition according to claim 1, wherein a ratio (B/A) of a content B of the fulvic acid to a content A of the carbon black is 0.0001 to 0.5.

7. The carbon black composition according to claim 1, wherein the hydrophilic functional group includes at least one of a hydroxy group and a carboxy group.

8. The carbon black composition according to claim 1, wherein the carbon black composition is a pigment dispersion liquid containing a dispersion medium containing water, and
the carbon black is dispersed in the dispersion medium.

9. The carbon black composition according to claim 8, wherein
the hydrophilic functional group contains an acidic group, and
the carbon black is a self-dispersible pigment dispersed in the dispersion medium.

10. The carbon black composition according to claim 8, wherein the carbon black is a resin-dispersed pigment dispersed in the dispersion medium with a resin.

11. An ink composition comprising the carbon black composition according to claim 1.

12. A recording method comprising attaching the ink composition according to claim 11 to a recording medium.

13. A recorded matter comprising the ink composition according to claim 11 adhering to a recording medium.
